(19) United States
(12) Patent Application Publication
(10) Pub. No.: US 2014/0096653 A1
(43) Pub. Date: Apr. 10, 2014

(54) RATCHET WRENCH WITH ADJUSTABLE SOCKET

(71) Applicant: Alex Pirseyedi, Toronto (CA)

(72) Inventor: Alex Pirseyedi, Toronto (CA)

(21) Appl. No.: 14/046,848

(22) Filed: Oct. 4, 2013

Related U.S. Application Data
(60) Provisional application No. 61/709,396, filed on Oct. 4, 2012.

(51) Int. Cl. B25B 13/12; B25B 13/46

(52) U.S. Cl. CPC B25B 13/12; B25B 13/46
USPC 81/60

(57) ABSTRACT

A ratchet comprises a handle, an adjustable socket, and a coupling fixedly coupling the adjustable socket to the handle.

### BACKGROUND OF THE INVENTION

1. Field of the Invention

The present invention relates to a ratchet wrench and, in particular, to a ratchet wrench with an adjustable socket.

2. Description of the Related Art

U.S. Pat. No. 7,707,916 which issued on May 4, 2010 to Pirseyedi, and the full disclosure of which is incorporated herein by reference, discloses an adjustable socket. The adjustable socket comprises a housing with a longitudinal axis. A collar is couplable to and movable along the housing. A lower end of the collar is bevelled. A plurality of circumferentially spaced apertures extend through the housing. A jaw is mounted in each aperture for slidable, radial movement through the aperture. Each jaw has a flat inward face and a bevelled outward face. The jaws are biased radially outwardly away from the longitudinal axis of the housing. Rotation of the collar around the housing in a first direction forces the bevelled end of the collar against the bevelled faces of the jaws. This forces the jaws radially inwardly and forces their inward faces against a fastener located between the inward faces. Rotation of the collar in the opposite direction allows the jaws to be biased radially outwardly to release the fastener.

### SUMMARY OF THE INVENTION

There is provided a ratchet wrench comprising a handle, an adjustable socket, and a coupling fixedly coupling the adjustable socket to the handle. The adjustable socket may include a drive aperture. The coupling may be mated to the adjustable socket by an interference fit between the coupling an annular inner wall of the socket extending about the drive aperture.

There is also provided a ratchet wrench comprising a handle, an adjustable socket, and a coupling which couples the adjustable socket to the handle. The adjustable socket has a housing with a central longitudinal axis. There is a plurality of apertures extending through the housing. There is a plurality of jaws. Each jaw is slidably moveable through a corresponding one of the apertures. Each jaw is biased away from the central longitudinal axis of the housing. There is an adjusting collar rotatably coupled to the housing. Rotation of the collar about the housing in a first rotational direction forces the jaws radially inwards. Rotation of the collar about the housing in a second rotational direction allows the jaws to be biased radially outwards.

The adjustable socket may have six jaws. The adjustable socket may include a drive aperture. The coupling may be mated to the adjustable socket by an interference fit between the coupling an annular inner wall of the socket extending about the drive aperture. The socket may include a plurality of grooves in an inner wall thereof extending about the drive aperture. The coupling may include a plurality of splines. The grooves may be configured to receive the splines. Each of the grooves may have bevelled edges. Each of the splines may have bevelled edges.

There is further provided a ratchet wrench comprising a handle and an adjustable socket having a mating portion which mates with the handle.

There is still further provided a ratchet wrench comprising a handle and an adjustable socket having a housing with a central longitudinal axis and mating portion. There is a plurality of apertures extending through the housing. There is a plurality of jaws. Each jaw is slidably moveable through a corresponding one of the apertures. Each jaw is biased away from the central longitudinal axis of the housing. There is an adjusting collar rotatably coupled to the housing. Rotation of the collar about the housing in a first rotational direction forces the jaws radially inwards. Rotation of the collar about the housing in a second rotational direction allows the jaws to be biased radially outwards. The mating portion of the housing mates with the handle. The adjustable socket may have six jaws.

### BRIEF DESCRIPTIONS OF DRAWINGS

The invention will be more readily understood from the following description of the embodiments thereof given, by way of example only, with reference to the accompanying drawings, in which:

FIG. 1 is a perspective view of a first embodiment of an improved ratchet wrench;

FIG. 2 is an exploded view of the ratchet wrench of FIG. 1;

FIG. 3A is an exploded view of an adjustable socket of the ratchet wrench of FIG. 1;

FIG. 3B is an exploded view of the adjustable socket and a coupling of the ratchet wrench of FIG. 1;

FIG. 4 is an enlarged view of the adjustable socket and coupling of the ratchet wrench of FIG. 1;

FIG. 5 is a perspective view of a second embodiment of an improved ratchet wrench;

FIG. 6 is an enlarged view of an adjustable socket of the ratchet wrench of FIG. 5;

FIG. 7 is a perspective view of a housing of the adjustable socket of FIG. 5;

FIG. 8 is an elevation view of the housing of the adjustable socket of FIG. 5; and

FIG. 9 is a sectional view taken along line 9-9 of FIG. 8.

### DESCRIPTIONS OF THE PREFERRED EMBODIMENTS

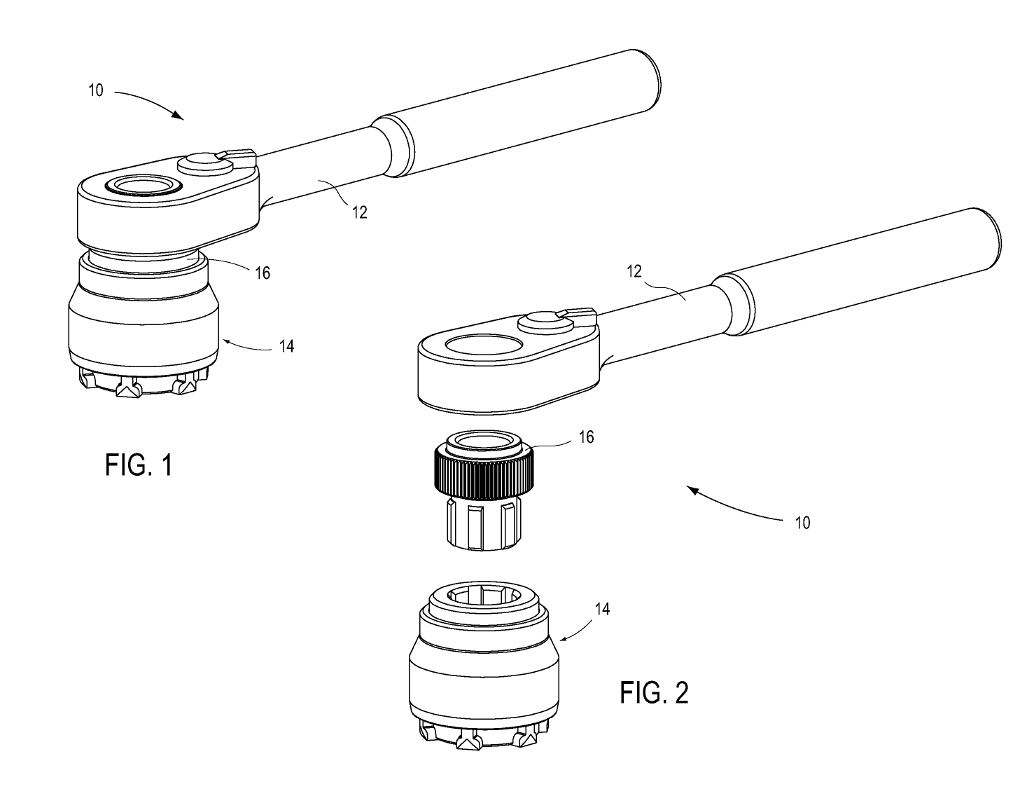

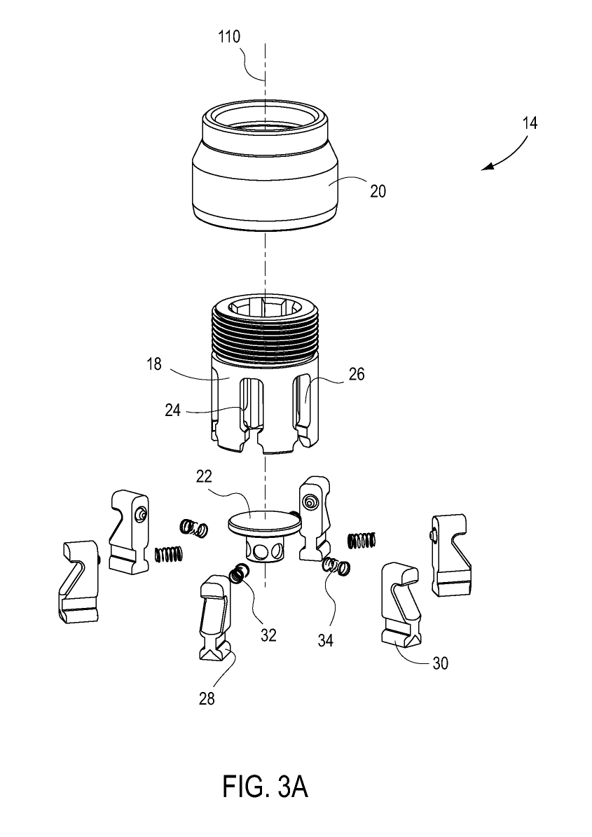

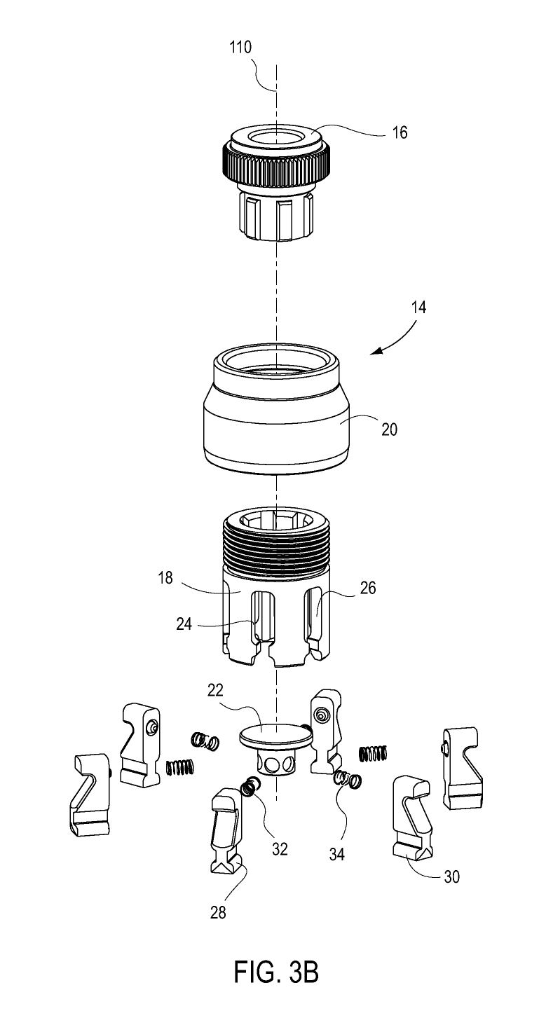

Referring to the drawings and first to FIGS. 1 and 2, there is shown a first embodiment of an improved ratchet wrench 10. The ratchet wrench 10 generally comprises a handle 12, a socket 14, and a coupling 16 which fixedly couples the handle and socket. In this example, the socket 14 is an adjustable socket similar to the type disclosed in U.S. Pat. No. 7,707,916 to Pirseyedi and is shown in greater detail in FIGS. 3A and 3B. The socket 14 includes a housing 18, an adjusting collar 20, and a retainer 22. There is a plurality of apertures, for example, apertures 24 and 26 extending through the housing 18. A corresponding jaw, for example jaw 28 or jaw 30, is mounted in each aperture for slidable, radial movement through the aperture. Each jaw is biased radially outward from a longitudinal axis 110 of the housing 18 by a corresponding biasing member, for example, spring 32 or spring 34. Each biasing member extends between the retainer 22 and a corresponding jaw.

The collar 20 is rotatably coupled to the housing 18 and is movable along the housing. Rotation of the collar 20 around the housing 18 in a first rotational direction forces the jaws radially inwardly and against a fastener (not shown) located between the jaws. Rotation of the collar 20 in a second rotational direction, which is opposite to the first rotational direction, allows the jaws to be biased radially outwardly to release the fastener. Accordingly, as thus far described, the socket 14 is conventional.

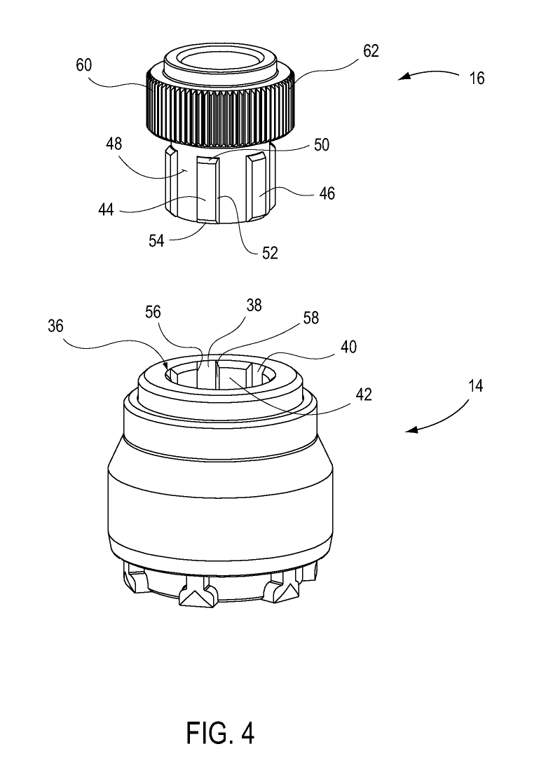

However, as best shown in FIG. 4, a drive aperture 36 of the socket 14 is provided with a plurality of circumferential grooves, for example grooves 38 and 40, on an inner wall 42 thereof. The grooves are configured to receive corresponding circumferential splines, for example splines 44 and 46, which are disposed on a first mating portion 48 of the coupling 16 which mates with the socket 14. The splines 44 and 46 each have bevelled edges, for example, bevelled edges 50, 52 and 54 which are shown for a first one of the splines 44. The grooves 38 and 40 in the drive aperture 36 of the socket 14 also have bevelled edges, for example, bevelled edges 56 and 58 which are shown for a first one of the grooves 38. The coupling 16 also includes a second mating portion 60 which mates with the handle 12. The second mating portion 60 is conventional and includes a ratchet gear 62.

The first mating portion 48 of the coupling 16 is mated to the drive aperture 36 of the socket 14 by an interference fit (i.e. a press fit or a friction fit). In other examples other means to mate the coupling 16 to the socket 14 may be employed. The second mating portion 60 of the coupling 16 is mated to the handle 12. The socket 14 is thereby fixedly and rotatably coupled to the handle 12.

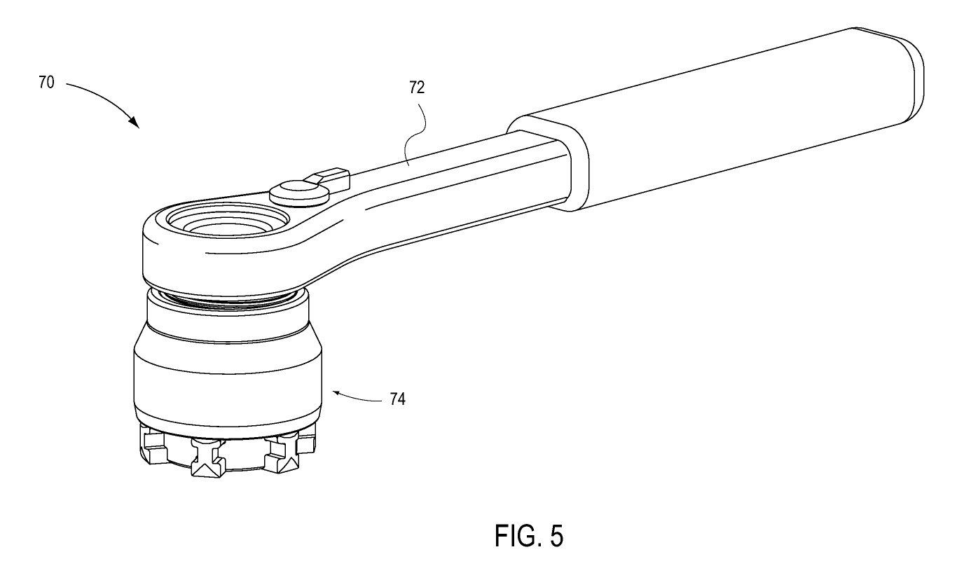

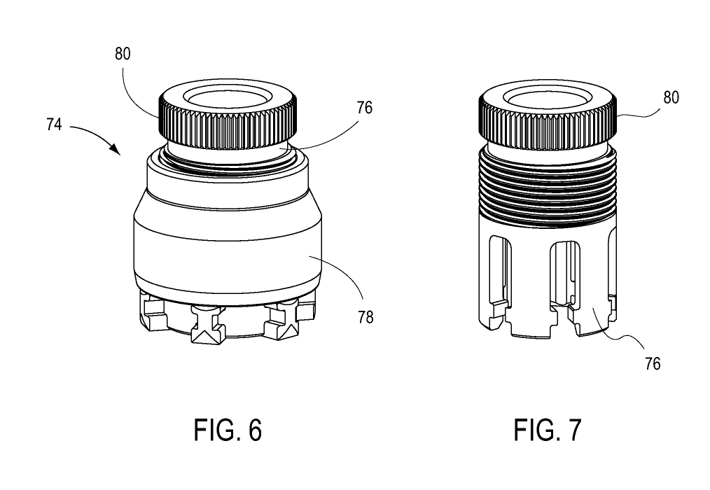

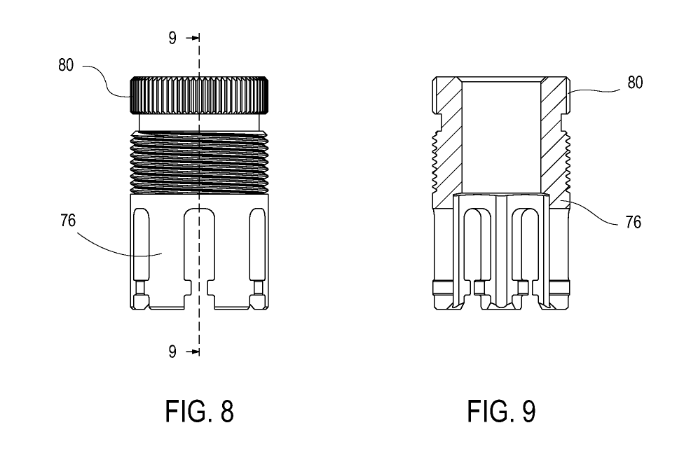

Referring now to FIG. 5, there is shown a second embodiment of an improved ratchet wrench 70. The ratchet wrench 70 comprises a handle 72 and a socket 74 which is fixedly coupled to the handle. In this example, the socket 74 is an adjustable socket similar to the type disclosed in U.S. Pat. No. 7,707,916 and, as best shown in FIG. 6, includes a housing 76 and a collar 78 which is coupled to and moveable along the housing. However, as best shown in FIGS. 6 to 8, the housing 76 of the socket 74 further includes a mating portion 80 which, in this example, is a ratchet gear that mates with handle 72. The socket 74 is thereby fixedly and rotatably mated to the handle 72.

It will be understood by a person skilled in the art that many of the details provided above are by way of example only, and are not intended to limit the scope of the invention which is to be determined with reference to the following claims.

What is claimed is:

1. A ratchet wrench comprising:
a handle;
an adjustable socket; and
a coupling fixedly coupling the adjustable socket to the handle.

2. The ratchet wrench as claimed in claim 1 wherein the adjustable socket includes a drive aperture and the coupling is mated to the adjustable socket by an interference fit between the coupling an annular inner wall of the socket extending about the drive aperture.

3. A ratchet wrench comprising:
a handle;
an adjustable socket having:
a housing with a central longitudinal axis,
a plurality of apertures extending through the housing,
a plurality of jaws, each jaw being slidably moveable through a corresponding one of the apertures and each jaw being biased away from the central longitudinal axis of the housing, and
an adjusting collar rotatably coupled to the housing, wherein rotation of the collar about the housing in a first rotational direction forces the jaws radially inwards and rotation of the collar about the housing in a second rotational direction allows the jaws to be biased radially outwards; and
a coupling which couples the adjustable socket to the handle.

4. The ratchet wrench as claimed in claim 3 wherein the adjustable socket has six jaws.

5. The ratchet wrench as claimed in claim 3 wherein the adjustable socket includes a drive aperture and the coupling is mated to the adjustable socket by an interference fit between the coupling an annular inner wall of the socket extending about the drive aperture.

6. The ratchet wrench as claimed in claim 5 wherein the socket includes a plurality of grooves in an inner wall thereof extending about the drive aperture and the coupling includes a plurality of splines, wherein the grooves are configured to receive the splines.

7. The ratchet wrench as claimed in claim 6 wherein each of the grooves has bevelled edges and each of the splines has bevelled edges.

8. A ratchet wrench comprising:
a handle; and
an adjustable socket having a mating portion which mates with the handle.

9. A ratchet wrench comprising:
a handle; and
an adjustable socket having:
a housing with a central longitudinal axis and a mating portion,
a plurality of apertures extending through the housing,
a plurality of jaws, each jaw being slidably moveable through a corresponding one of the apertures and each jaw being biased away from the central longitudinal axis of the housing, and
an adjusting collar rotatably coupled to the housing, wherein rotation of the collar about the housing in a first rotational direction forces the jaws radially inwards and rotation of the collar about the housing in a second rotational direction allows the jaws to be biased radially outwards; and
wherein the mating portion of the housing mates with the handle.

10. The ratchet wrench as claimed in claim 9 wherein the adjustable socket has six jaws.
